(19) United States
(12) Patent Application Publication
(10) Pub. No.: US 2012/0153216 A1
(43) Pub. Date: Jun. 21, 2012

(54) High Transverse Thermal Conductivity Fiber Reinforced Polymeric Composites

(76) Inventor: Matthew Wrosch, San Diego, CA (US)

(21) Appl. No.: 13/332,350

(22) Filed: Dec. 20, 2011

Related U.S. Application Data
(60) Provisional application No. 61/425,616, filed on Dec. 21, 2010.

(51) Int. Cl. C09K 5/14; C04B 35/64; B82Y 30/00

(52) U.S. Cl. 252/74; 264/640; 977/779

(57) ABSTRACT

High thermal conductivity sintered metallic networks are provided for enhancing the transverse thermal conductivity of fiber reinforced polymeric materials. The approach establishes sintered metallic networks in both the intratow and interlaminar regions of a FRP part after appropriate thermal processing Dispersing metallic nanoparticles into a fluxing polymeric resin, and optionally mixing in low and high melting point metallic particles, can establish continuous metallurgical networks through the thickness of a FRP laminate. The fluxing polymeric resin has the dual benefit of reducing native oxides on the metallic fillers to aid the sintering reactions, and also to tailor the rheological properties to yield usable material embodiments with limited impact on material density. The high intrinsic thermal conductivity of the metallic networks yields a FRP part with enhanced transverse thermal conductivity.

### CROSS-REFERENCE TO RELATED APPLICATION(S)

This application claims the benefit of U.S. Provisional Patent Application No. 61/425,616, filed Dec. 21, 2010, the contents of which are hereby incorporated by reference in its entirety.

### FIELD

The invention relates generally to high thermal conductivity sintered metallic networks for enhancing the transverse thermal conductivity of fiber reinforced polymeric materials.

### BACKGROUND

Fiber-reinforced polymer (“FRP”) materials are used today in a variety of applications ranging from military and commercial aircraft, satellite structures, automobiles and rocket housings. FRPs are the preferred technology for all these applications because of their exemplary specific strength properties. In addition to the mechanical characteristics, approaches for adding further functionality to FRP systems, particularly electrical and thermal transfer characteristics, are continuously being sought after due to the wide variety of applications that could also benefit from such developments.

A FRP composite is a material system composed of two main components—a polymeric matrix and a reinforcing fiber (or fabric). In practice, dry fiber reinforcements composed of glass, carbon, ceramic, or metals are impregnated and/or wetted-out with a polymeric resin that can then be molded or formed into complex shapes prior to being cured and hardened. For applications requiring very high specific strength (strength to weight ratio), high-modulus carbon fibers in conjunction with a cured polymeric resin matrix yields a material system with high specific strength.

Sintered metallic networks refer to a network of metallic particles that have been joined together by thermal processing. In some processes, the metallic particles are heated to a temperature that is substantial enough to cause their surfaces to become liquid and to wet neighboring particles. Upon cooling, the particles are bonded together into a continuous metallic structure. In other processes, the metallic particles are composed of various melting point metals and/or alloys. When heated to a temperature substantial enough to cause melting of the lower temperature particles, the liquid metals wet the neighboring solid particles and alloy with them, leading to isothermal solidification and a continuous metallic network. In still other processes, combinations of the two above-described processes are possible and desirable in certain circumstances.

One particularly sought after characteristic for FRPs is enhanced transverse thermal conductivity. One problem is that in spite of the high intrinsic thermal conductivity of certain fiber reinforcements (e.g., carbon, some metals and ceramics), the nature of the constituents and the number of interfaces through the thickness of a FRP part severely hinders transverse thermal conductivity. There are at least three reasons for this: 1) the polymeric resin component is typically a poor thermal conductor on its own; 2) z-direction thermal conductivity in FRPs relies on point to point contact of the fiber filaments, which are typically coated with a polymeric resin; and 3) the interfaces between the polymer and the fibers are not conducive for transferring thermal energy. Thus, to achieve the desired mechanical properties, a number of layers of resin and fiber need to be utilized, which ultimately increases the number of interfaces through the thickness of the FRP part, thereby severely hindering transverse thermal conductivity. Therefore, for applications that would otherwise benefit from the specific strength of FRPs but require high thermal conductivity, heavier material alternatives must still be utilized to enable better heat dissipation. This need for heavier material alternatives reduces fuel efficiency and increases the costs of operation.

Accordingly, there is a need for a high intrinsic thermal conductivity sintered metallic network that can increase the effective transverse thermal conductivity of FRPs without increasing their density.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one exemplary embodiment, a process for forming a fiber reinforced polymeric composite material is described, comprising doping a fluxing polymeric component with metallic nanoparticles to form a filled polymer resin; impregnating at least one fiber with the filled polymer resin to coat the fiber or fibers to form at least one impregnated fiber; and curing the at least one impregnated fiber to form sintered metallic networks in intratow and interlaminar regions; wherein the sintered metallic networks increase transverse thermal conductivity of the fiber reinforced polymeric material by at least two orders of magnitude.

In another exemplary embodiment, a fiber reinforced polymeric composite material is described which comprises: a fiber selected from the group consisting of: carbon fiber, glass fiber, polyamide fiber, stainless steel fiber, copper fiber and amorphous metal fiber; and a filled polymer resin comprising a fluxing polymeric resin and a dispersion of metallic nanoparticles; wherein the fiber is impregnated with the filled polymer resin to form sintered metallic networks; and wherein the sintered metallic networks increase transverse thermal conductivity of the fiber reinforced polymeric material by at least two orders of magnitude.

In some embodiments, the fluxing polymeric resin is doped with a low melting point metal powder in addition to doping with metallic nanoparticles. In an alternative embodiment, the fluxing polymeric resin is doped with a high melting point metal powder in addition to doping with metallic nanoparticles. In an exemplary embodiment, the fluxing polymeric resin is doped with a low melting point metal powder and a high melting point metal powder in addition to doping with metallic nanoparticles.

In various embodiments, the optional low melting point metal powder is selected from the group consisting of: Sn, Bi, Pb, Cd, Zn, In, Te, Tl, Sb, Se, Ag, and alloys, or mixtures thereof. In other embodiments, the low melting point metal powder is SnInAg or SnBiAg. Additionally, in some embodiments, the high melting point metal powder can be Cu.

### BRIEF DESCRIPTION OF THE DRAWINGS

FIG. 1 is a cross-sectional perspective view of a FRP showing resin-rich regions.

FIG. 2 is a cut-away view of a sintered metallic network in the intratow region.

FIG. 3 is a perspective view of a sintered metallic network in the interlaminar region.

FIG. 4 is a perspective view of metallic bridging between carbon fiber filaments after nanoparticle sintering.

### DETAILED DESCRIPTION

A detailed description of methods and systems for enhancing the transverse thermal conductivity of fiber reinforced polymeric materials in the field of sintered metallic networks are presented. More particularly, methods and systems are presented for establishing sintered metallic networks in both intratow and interlaminar regions of a FRP part after appropriate thermal processing.

Exemplary FRP materials for use in the present disclosure may comprise at least one type of fiber selected from carbon fiber, glass fiber, wholly aromatic polyamide fiber, stainless steel fiber, copper fiber and amorphous metal fiber, for example.

### Sintered Metallic Networks

The process for increasing transverse thermal conductivity of FRPs involves establishing sintered metallic networks in both the intratow and interlaminar regions of a FRP to create metallic paths/vias for thermal transfer. For purposes of this disclosure, intratow regions refer to filament-to-filament regions and interlaminar regions refer to ply-to-ply regions.

A sintered metallic network refers to a network of metallic particles that have been joined together typically by thermal processing. In some processes, the metallic particles are heated to a temperature that is substantial enough to cause their surfaces to become liquid and to wet neighboring particles. Upon cooling, the particles are bonded together into a continuous metallic structure. In other processes, the metallic particles are composed of various melting point metals and/or alloys. When heated to a temperature substantial enough to cause melting of the lower temperature particles, the liquid metals wet the neighboring solid particles and alloy with them, leading to isothermal solidification and a continuous metallic network. In still other processes, combinations of the two above-described processes are possible and suitable in certain circumstances.

In various exemplary embodiments, sintered metallic networks can be created by first doping, for example, a fluxing polymeric resin component with the metallic particles of interest to form a filled polymer resin, impregnating fibers/fabric with the filled polymer resin and processing the resin-impregnated fibers/fabric into the desired shape. Lastly, the resin-impregnated fibers/fabric can be subjected to a curing process.

In an exemplary embodiment, a filled polymer resin useful for establishing metallurgical channels in a FRP is composed of a fluxing polymeric resin, a dispersion of metallic nanoparticles within the fluxing resin, optionally additional low melting point metal powders (solders), and optionally additional high melting point metal powders (Ag, Cu and similar metals).

### Fluxing Polymeric Resin

The fluxing polymeric resin functions principally to adhere the cured composition to the reinforcing fibers, to provide chemical binding sites for the reaction products after curing, and to increase the cohesive strength of the cured polymeric composite.

Fluxing polymeric resins contemplated for use in the practice of the exemplary embodiments can include any thermosetting resin (either monomeric or polymeric) which can be cross-linked by the curing agent, a metal catalyst or a hydroxyl group-bearing agent. Various resins which are presently known to meet this requirement include epoxies, phenolics, novalacs (both phenolic and cresolic), polyurethanes, polyimides, bismaleimides, maleimides, cyanate esters, polyvinyl alcohols, polyesters, polyureas, and the like. Other resin systems may be modified to be cross-linkable by the curing agent, a metal catalyst or a hydroxyl group-bearing agent. Examples of such resins are acrylics, rubbers (butyl, nitrile, etc), polyamides, polyacrylates, polyethers, polysulfones, polyethylenes, polypropylenes, polysiloxanes, polyvinyl acetates/polyvinyl esters, polyolefins, cyanoacrylates, polystyrenes, and the like.

In various other exemplary embodiments, polymeric resins that can be modified to contain at least one of the following functional groups: anhydrides, carboxylic acids, amides, imides, amines, alcohols/phenols, aldehydes/ketones, nitro compounds, nitriles, carbamates, isocyanates, amino acids/peptides, thiols, sulfonamides, semicarbazones, oximes, hydrazones, cyanohydrins, ureas, phosphoric esters/acids, thiophosphoric esters/acids, phosphonic esters/acids, phosphites, phosphonamides, sulfonic esters/acids or other functional groups known to those of skill in the art to act as reactive sites for polymerization may be used. A combination of these and other resins, such as non-cross-linkable thermoplastic resins, may also be used as the fluxing polymeric resin component.

### Metallic Nanoparticles

Metallic nanoparticles contemplated for use in the present disclosure can include the alkali metals Li, Na, K, Rb, Cs, Fr; the alkali earth metals Be, Mg, Ca, Sr, Ba, and Ra; the transition metals Sc, Ti, V, Cr, Mn, Fe, Co, Ni, Cu, Zn, Y, Zr, Nb, Mo, Tc, Ru, Rh, Pd, Ag, Qd, La, Hf, Ta, W, Re, Os, Ir, Pt, and Au; metals of the lanthanide series of metals; metals of the actinide series of metals; and post-transition metals that include Al, Ga, In, Si, Ge, Pb, Sb, Te, and Bi, or any combination thereof. Metallic nanoparticles may further comprise silver oxide, copper oxide, gold oxide, zinc oxide, cadmium oxide, palladium oxide, iridium oxide, ruthenium oxide, osmium oxide, rhodium oxide, platinum oxide, iron oxide, nickel oxide, cobalt oxide, indium oxide, or any combination thereof.

In various exemplary embodiments, the metallic nanoparticles can comprise individual nanoparticles, particle agglomerate comprised of two or more individual nanoparticles, particle floc comprised of two or more individual nanoparticles, or any combination thereof. In some exemplary embodiments, substantially all of the metallic nanoparticles are agglomerated. Alternatively, in other exemplary embodiments, substantially all of the metallic nanoparticles are discrete individual nanoparticles.

### Metal Powders

The filled polymer resin system may optionally include additional low melting point metal powders and may further optionally include high melting point metal powders. In various exemplary embodiments, the powders can comprise round particles or flakes. The metal powders should comprise a range of sizes to improve packing density. In some adhesive compositions, the round particles have a maximum size of about 100 microns and could be less than about 50 microns in size. Flakes may also range from about 1 to about 50 microns in size. These are non-limiting examples, and other sizes may be used. Though it is well known that oxide removal from fine metal powders is more difficult due to the higher surface area, the fluxing activity of the fluxing polymeric resin can be sufficiently high to provide satisfactory oxide removal.

Any solderable or alloyable metal, alloy or metal mixture is usable as the high melting point powder. For example, the high melting point metal powder may be a material selected from the group comprising copper, silver, aluminum, nickel, gold, platinum, palladium, beryllium, rhodium, nickel, cobalt, iron, molybdenum and alloys or mixtures thereof. In particular, the high melting point metals may be copper, silver, nickel and/or gold. When spherical powders are used, the powders can have a smooth, even morphology, as is typically produced using gas atomization methods. The high melting point powder can be comprised of a mixture of spherical powder and flake. The use of spherical powders permits a high metal loading in the adhesive composition, which is desirable for high thermal and electrical conductivity, while the addition of flake helps improve the rheology of the adhesive and facilitates application or dispensing using conventional equipment used in the fabrication of electronic assemblies. It also serves to prevent settling of the filler particles in the resin, maintaining the homogeneous nature of the material eliminating the need to re-mix the material prior to use. The high melting point powder makes up about 10-90% by weight of the total powder composition in an exemplary embodiment. In other exemplary embodiments, the high melting point powder makes up about 50-60% by weight of the total powder composition.

Non-limiting examples of solderable low melting point metal powders can comprise one or more elements selected from the group comprising Sn, Bi, Pb, Cd, Zn, In, Te, Tl, Sb, Se, Ag, and alloys, or mixtures thereof. These mixtures can include, but are in no way limited to, SnInAg and SnBiAg. In an exemplary embodiment, the low melting point powder can comprise a commercial solder powder prepared from a combination of the metals Sn and Pb.

Further, various non-limiting examples of high melting point metal powders contemplated for use in the present disclosure may comprise electronic grade copper metal, copper powder, silver powder, aluminum powder, gold powder, platinum powder, palladium powder, beryllium powder, rhodium powder, nickel powder, cobalt powder, iron powder, molybdenum powder, as well as high-melting point alloys of any two or more of these metals, may be employed. In one exemplary embodiment, the high melting point electronic grade copper may be supplied by Ultrafine Powders, Inc. of Woonsocket R.I., lot 04-277 and other lots.

### Doping Step

The filled polymer resin can be formed by first doping a fluxing polymeric resin component with the metallic nanoparticles of interest. A low melting point metal powder, a high melting point metal powder or a combination thereof may optionally be added during the doping process. Various doping processes as understood by one of ordinary skill in the art may be suitable for this step.

### Impregnating Step

When the filled polymer resin is impregnated into the dry fibers/fabrics, the resin component and the metallic nanoparticles are wicked into and around the fiber tows, sufficiently coating the surfaces of the fiber filaments. The surface of an “impregnated” fiber filament will be coated with the filled polymer resin, which can comprise a fluxing polymeric resin component and metallic nanoparticles. If the optional low melting point metallic fillers and high melting point metallic fillers are utilized, they will remain dispersed within the interlaminar regions. Therefore, the presence of both low and high melting point fillers within the interlaminar regions can be found.

### Curing Step

Upon curing at appropriate temperatures and for sufficient amounts of time, the metallic nanoparticles exhibit melting point depression at their surfaces and bond together via a sintering mechanism. In doing so, continuous metallic networks in both the intratow and interlaminar regions of a fiber bundle are thereby created, rendering thermally (and electrically) conductive paths between fiber filaments and plies.

This process is enabled by utilizing a fluxing polymeric resin as the medium for the sintering reactions to reduce native oxides at the surfaces of the metallic fillers and enhance the wettability of the particles. Furthermore, if an optional low melting point powder is utilized, upon curing to appropriate temperatures for sufficient times, the low melting point metallic filler will melt and alloy with the metallic nanoparticles, creating additional metallic channels through the FRP. If optional high melting point metallic fillers are also included, the low melting point metallic filler will also wet and alloy with the high melting point particles during cure as well.

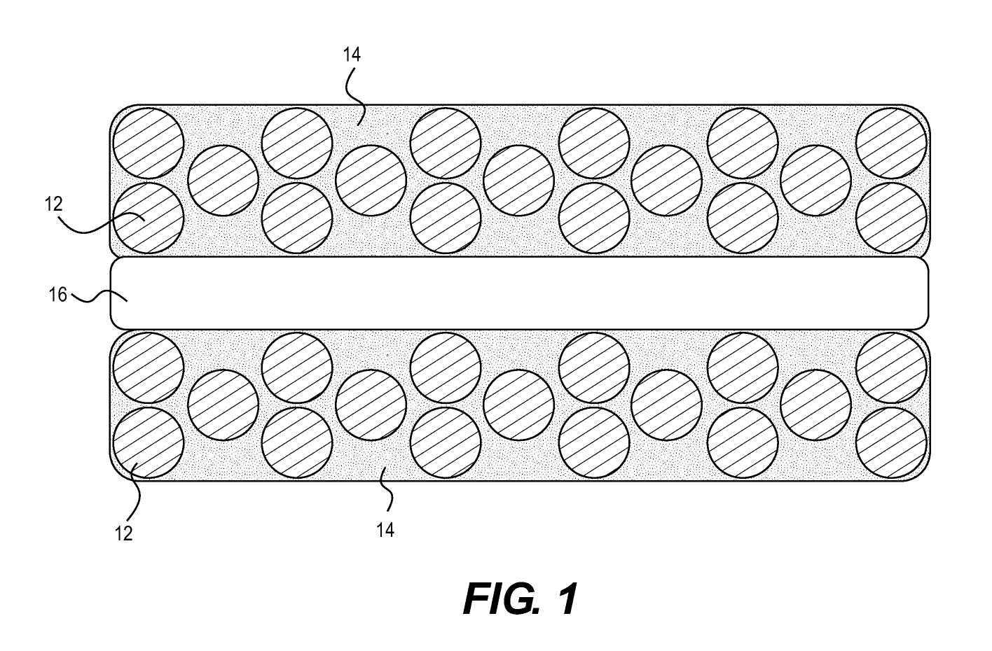

FIG. 1 is a cross-sectional view of a FRP showing two sets of resin-rich regions 14 enclosing carbon fibers 12 that are separated by a resin rich interface 16. As can be seen, there are no intratow “connections” between the carbon fibers 12 in the respective resin-rich regions 14.

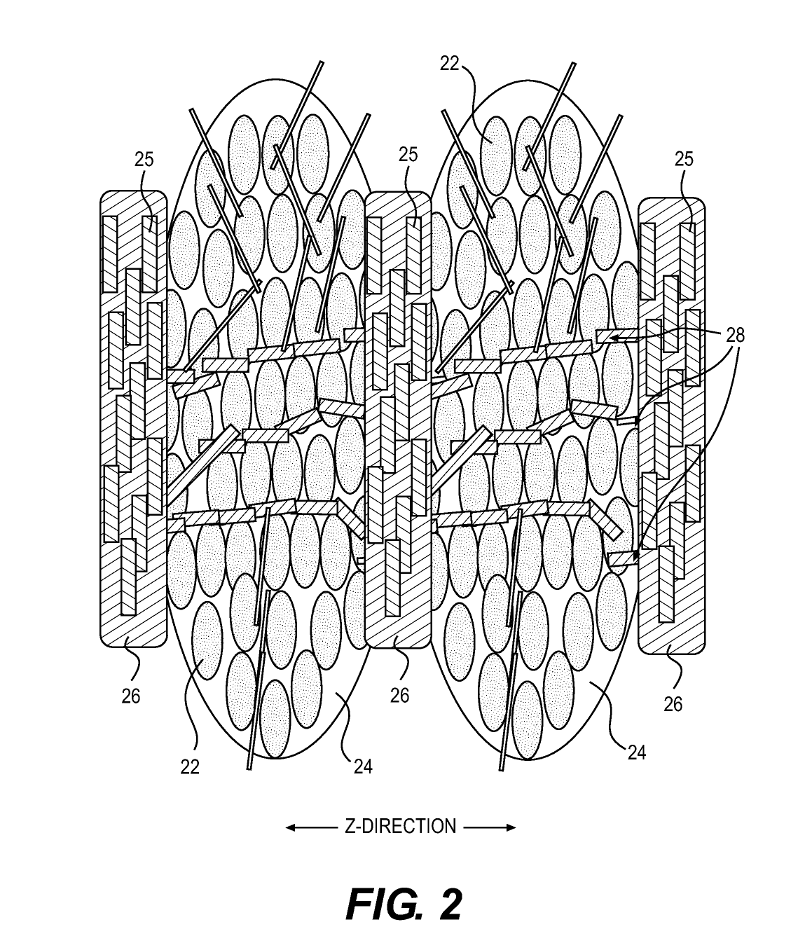

FIG. 2 is a cut-away view of an exemplary sintered metallic network showing the intratow regions and sintered channels 28 therein. Conductive elements/materials 25 in resin interfaces 26 are networked/channeled to neighboring (z-direction) conductive elements/materials 25 via sintered through-tow channels 28 that “pass” through resin 24 that embodies fibers 22. As detailed above, the through-tow channels 28 allow for z-direction thermal and electrical conductivity, without compromising the integrity of the fiber system.

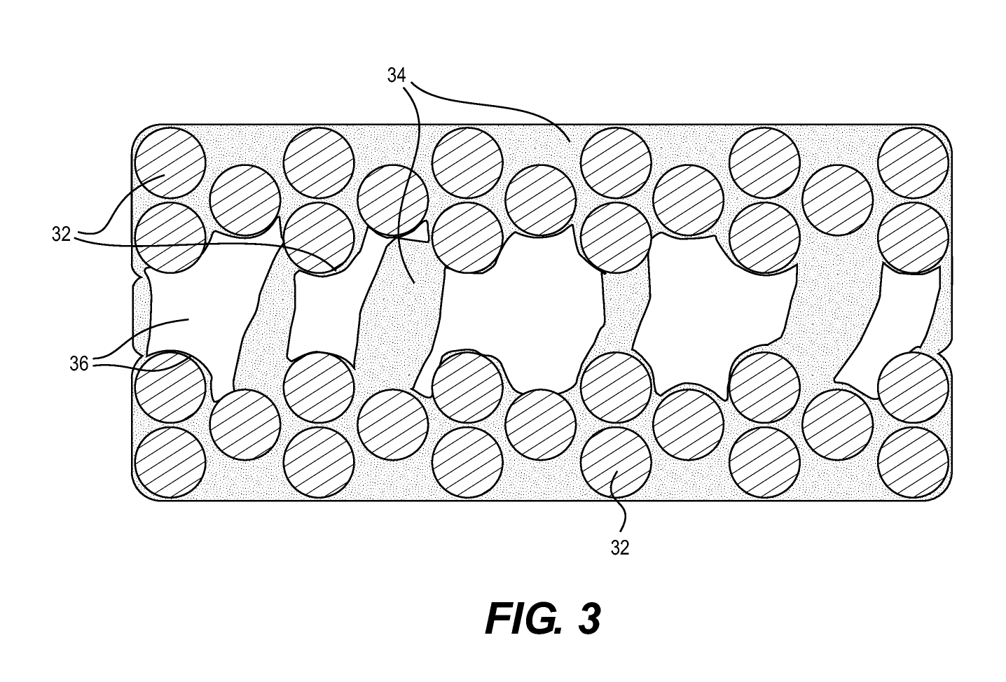

FIG. 3 is a cross-sectional view of an exemplary sintered metallic network in the interlaminar region showing metallized carbon fibers 32 with interlaminar connections 36 across the polymer matrix 34. Breeching of the interlaminar polymer matrix 34 by the metallurgical connections 36 enables thermal and/or electrical “continuity” between upper and lower carbon fibers 32.

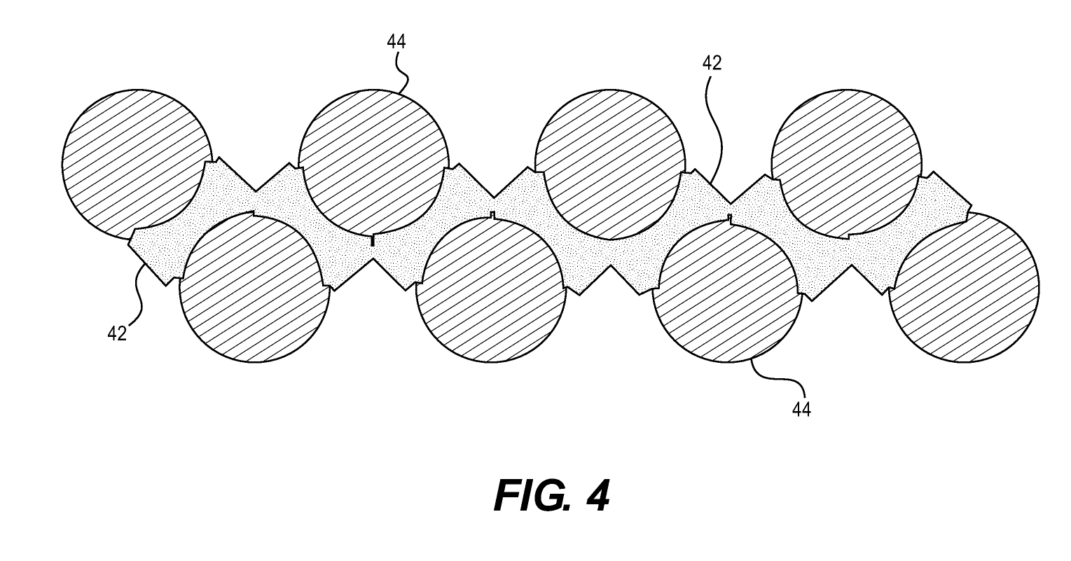

FIG. 4 is a simplified view of sintered metallic nanoparticles 42 causing metallic bonding between fiber filaments 44 in the intratow region.

The present exemplary embodiments achieve superior thermally conductivity in FRP composites. Specifically, establishing sintered metallic networks through the thickness of a cured FRP part enhances transverse effective thermal conductivity of a FRP. The sintered metallic networks are significantly higher in intrinsic thermal conductivity than the FRP on its own, typically by at least two orders of magnitude, and continuity of the sintered metallic network through the thickness of the FRP works to enhance transverse thermal conductivity by overcoming the interfacial thermal resistance in both the intratow and interlaminar regions. Additionally, the present exemplary embodiment(s) yields a FRP part with enhanced transverse thermal conductivity without increasing their material density, thereby avoiding reduced fuel efficiency and increased costs due to heavier material alternatives.

### EXAMPLES

In the examples that follow, the conditions such as weight ratios, curing times, etc., can easily be optimized for the particular intended use.

### Example 1

### Filled Polymer Resin

In one exemplary embodiment, a filled polymer resin is prepared by dispersing copper nanoparticles in acetone via sonification, mixing into the solution Bisphenol A diglycidyl ether, and then drying the solution of its acetone on a magnetic stir/hot-plate at approximately 100 degree C. for up to 24 hrs or so. The resin is then formulated by dissolving Hexahydrophthalic anhydride in Bisphenol A diglycidyl ether by warming the mixture to approximately 65 degree C. After stirring to form a homogeneous mixture, the blend was cooled to room temperature. mono-2-(methacryloyloxy)ethyl maleate, poly(ethylene glycol)methacrylate and azo biscyclohexanecarbontrile were then added with stirring to complete the polymer flux component of the adhesive composition. In a separate container, copper powder and 63Sn37Pb solder powder were mixed, using a hand blender. The copper powder used in the example was from Ultrafine Powders, Inc. of Woonsocket, R.I. This mixture of metal powders was then added to the polymer flux. Homogeneity was achieved by high shear mixing in a mechanical blender. Finally, the mixture was degassed under high vacuum.

The composition was dispensed into a mold and passed through approximately a 5 minute solder reflow cycle having a peak temperature of approximately 210 degree C., followed by a post cure at approximately 200 degree C. for approximately 20 minutes. Bulk thermal conductivity of the sample had a conductivity of: 41.798 W/m K.

### Example 2

### Impregnating and Curing FRP

Fibers of a FRP part are impregnated with the filled polymer resin as described above at room temperature using a solution prepregging technique akin to a filament winding process, i.e. dry-fibers are impregnated with the filled resin and wrapped over an aluminum mandrel under tension. A few layers of fibers are utilized to make a 3-ply section. Curing is conducted in a convention oven pre-heated to approximately 200 degree C. for approximately 60 minutes, or to a time/temperature combination above the melting temperature of the low-melting point filler and/or the pre-determined sintering temperature of the nanoparticles.

Alternatively, a dry woven fabric is laid flat and the filled resin is rolled over the dry fibers in such a way as to impregnate the dry perform fabric. Once the initial ply is impregnated, an additional dry fabric ply is laid over the pre-impregnated ply, and the process is repeated until the desirable number of plies is reached. Curing is conducted in a convention oven pre-heated to approximately 200 degree C. for approximately 60 minutes, or to a time/temperature combination above the melting temperature of the low-melting point filler and/or the pre-determined sintering temperature of the nanoparticles.

### Example 3

### Performance of High Transverse Thermal Conductivity FRP Composite

Test data for the example described above reveals a transverse thermal conductivity of 16.4 W/m-K for a single impregnated ply of carbon fiber with the filled resin. Thermal conductivity of 9.2 W/m-K is realized for a 2-ply configuration.

The composition is considered acceptable if the thermal conductivity is greater than 4 W/m-K, or as determined by the final end user for the particular configuration of interest.

It should be understood that due to the large number of commercially available metallic nanoparticles as well as the large number of low and high melting point metallic particles, a wide variety of combinations and modifications are possible. For example, lead-free solders can be used in place of lead-based solders. Other additional changes in the details, materials, steps and arrangement of parts, which have been herein described and illustrated to explain the nature of the exemplary embodiments, may be made by those skilled in the art within the principle and scope of this disclosure.

What is claimed is:

1. A process for forming a fiber reinforced polymeric composite material comprising the steps of:
doping a fluxing polymeric resin with metallic nanoparticles to form a filled polymer resin;
impregnating at least one fiber with the filled polymer resin to coat the fiber or fibers to form at least one impregnated fiber; and
curing the at least one impregnated fiber to form sintered metallic networks in intratow and interlaminar regions;
wherein the sintered metallic networks increase transverse thermal conductivity of the fiber reinforced polymeric composite material by two orders of magnitude or more.

2. The process according to claim 1, wherein the fluxing polymeric resin is doped with a low melting point metal powder in addition to doping with metallic nanoparticles.

3. The process according to claim 1, wherein the fluxing polymeric resin is doped with a high melting point metal powder in addition to doping with metallic nanoparticles.

4. The process according to claim 1, wherein the fluxing polymeric resin is doped with a low melting point metal powder and a high melting point metal powder in addition to doping with metallic nanoparticles.

5. The process according to claim 2, wherein the low melting point metal powder is selected from the group consisting of: Sn, Bi, Pb, Cd, Zn, In, Te, Tl, Sb, Se, Ag, and alloys, or mixtures thereof.

6. The process according to claim 2, wherein the low melting point metal powder is SnInAg or SnBiAg.

7. The process according to claim 3, wherein the high melting point metal powder is Cu.

8. A fiber reinforced polymeric composite material comprising:
a fiber selected from the group consisting of: carbon fiber, glass fiber, polyamide fiber, stainless steel fiber, copper fiber and amorphous metal fiber; and
a filled polymer resin comprising a fluxing polymeric resin and a dispersion of metallic nanoparticles;
wherein the fiber is impregnated with the filled polymer resin to form sintered metallic networks; and
wherein the sintered metallic networks increase transverse thermal conductivity of the fiber reinforced polymeric material by two orders of magnitude or more.

9. The fiber reinforced polymeric composite material of claim 8, fluxing polymeric resin is doped with a low melting point metal powder in addition to doping with metallic nanoparticles.

10. The fiber reinforced polymeric composite material of claim 8, wherein the fluxing polymeric resin is doped with a high melting point metal powder in addition to doping with metallic nanoparticles.

11. The fiber reinforced polymeric composite material of claim 8, wherein the fluxing polymeric resin is doped with a low melting point metal powder and a high melting point metal powder in addition to doping with metallic nanoparticles.

12. The fiber reinforced polymeric composite material of claim 9, wherein the low melting point metal powder is selected from the group consisting of: Sn, Bi, Pb, Cd, Zn, In, Te, Tl, Sb, Se, Ag, and alloys, or mixtures thereof.

13. The fiber reinforced polymeric composite material of claim 9, wherein the low melting point metal powder is SnInAg or SnBiAg.

14. The fiber reinforced polymeric composite material of claim 10, wherein the high melting point metal powder is Cu.
